(19) United States
(12) Patent Application Publication
(10) Pub. No.: US 2017/0190590 A1
(43) Pub. Date: Jul. 6, 2017

(54) Compression of ammonia synthesis and recycle gas

(71) Applicant: Derek Carlton Lennon, Is-Swieql (MT)

(72) Inventor: Derek Carlton Lennon, Is-Swieql (MT)

(21) Appl. No.: 14/987,779

(22) Filed: Jan. 5, 2016

(51) Int. Cl. C01C 1/04; F04C 18/16; C01B 3/02

(52) U.S. Cl. CPC C01C 1/04; C01B 3/025; F04C 18/16

(57) ABSTRACT

A method of producing ammonia by the compression of the synthesis and recycle gas by screw compressors enabling efficient small ammonia plants to be designed.

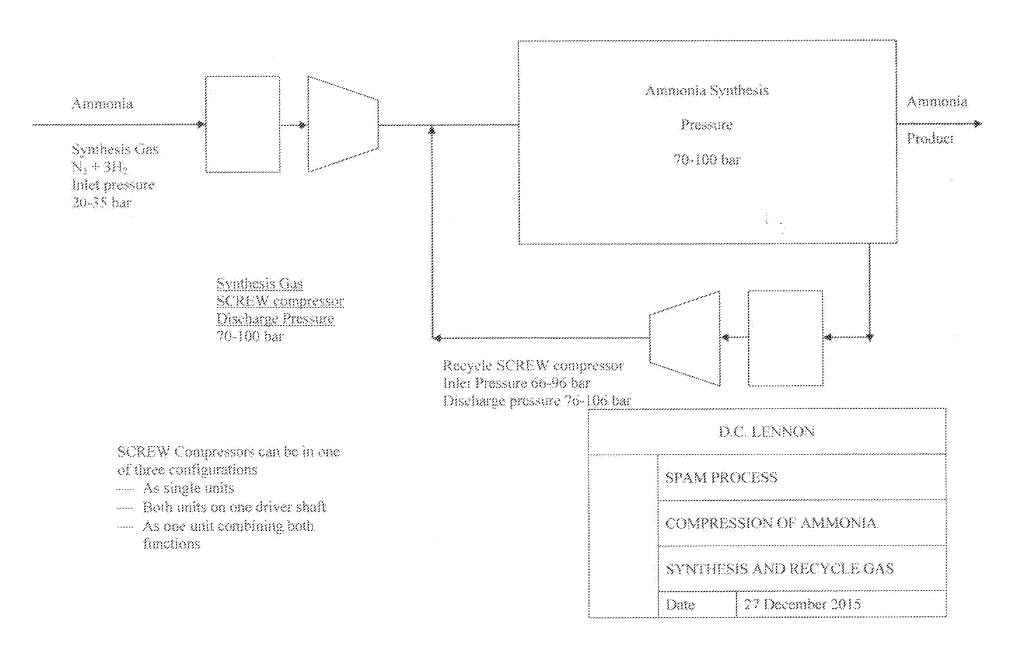

### DESCRIPTION AND PRIOR ART

The discovery of Haber and developments by Bosch of the reaction N2+3H2=2NH3 to produce ammonia was in relation to the World an epoch making discovery and led to ammonia being one of the top tonnage chemicals in World production.

There is no doubt that without this discovery the burgeoning world population would have been subject to increased starvation.

The first commercial production of 20 tonnes/day was by BASF in 1913. This enabled the Germans to produce nitrate explosives without the import of Chilean Saltpetre an important factor in World War 1.

One of the pioneers in the subsequent development of the ammonia synthesis was the Italian company Ammonia Casale who have remained a world leader.

They recommended a synthesis pressure of 600 atm so the ammonia ex the reactor could be condensed without a refrigeration compressor. Post World War 2 ammonia plants tended to have a capacity of around 300 tonnes/day the limitation being the size of the reciprocating synthesis compressors which in general were horizontally opposed units.

In Wyoming for example these plants were considered rather like gas stations serving an agricultural community of around 250 mile radius curve from the ammonia production. In 1954 Torresy and Hamilton produced designs for skid mounted units of 100 and 200 short tons/day of ammonia. These plants had horizontally opposed reciprocating synthesis gas driven by synchronous electric motors. Specific consumption in thermally equivalent gas was 50 MM BTU/metric tonne of ammonia. Some 30 of these plants which were fabricated in Germany and Austria were sold Worldwide and some are still operating including one in Sudan which was never started up because the government did not supply the gas. Commercially these plants were a success at the time because the buyer had only to provide the civil work for the foundations and the need for mechanical erection was eliminated.

In the 1960's the Kellogg International Corporation opened the era of mega-ammonia plants with a radical new design. This design involved raising steam from the primary and secondary reformer to supply steam turbines driving the centrifugal syn gas, recycle and refrigeration compressors. Gas consumption was reduced to around 30 MMBTU/metric tonne of ammonia with the plant having minimal electricity consumption The centrifugal compressors opened the way to increased flows and consequently higher ammonia capacity. The first plant to utilize the process was the Mississippi Chemical Corporation with a capacity of 1000 tonnes/day. However the physical limitations of centrifugal compressors meant it was not possible to design ammonia plants with a capacity below 500 metric tonnes/day.

The cost of ammonia production is largely based on two factors, the price of gas and the capital charges.

New ammonia plants of 2000 tonnes per day with an accompanying urea plant can cost around $1 billion and face major problems in implementation. Financiers cannot often obtain adequate information on the security of the market. The plants are often projected in areas where the field construction is difficult and the cost uncertain. Buyers normally want turnkey plants. This compels the contractor to include high levels of profit and contingency to cover the risk.

This all points to the need to develop small economic ammonia plants which can be situated in countries where the fertilizer consumption per unit area is low and also in countries where cheap fracked gas is available such as the United States.

Small ammonia plants will out succeed unless their gas consumption per tonne of ammonia is equivalent to that of a major scale plant and further their capital cost is pro-rata to that of the larger plant.

This invention sets out the use of screw compressors compressing to 100 bar which have never been used for the compression of synthesis gas and the recycle gas. This enables the utilization of the waste heat from the synthesis gas plant and with a conventional methane reformer system leads to a gas consumption of 30 MMBTU/tonne of ammonia.

The drawing shows the three configurations of the synthesis and recycle screw compressors which can be employed.

With improved designs in the reformer section, the utilization of the screw compressors and low cost skid assembly the capital cost can be matched pro-rata to a larger plant.

What is claimed:

1. A method, not utilized before, for compressing pure ammonia synthesis gas N2+3H2 or with limited content of methane and inert gases and recycle gas by screw compressors. The synthesis gas screw compressors compressing ammonia synthesis gas with a pressure of between 20 bar and 35 bar, with a volume limited to 60,000 standard cubic metres per hour up to 100 bar discharge pressure, according to the block flow drawing shown with the three different configurations of the compressor system.
That the method leads to the utilization of spare heat from conventional steam reformer and partial oxidation synthesis gas preparation units providing high energy efficiency and low capital cost.
